(19) United States
(12) Patent Application Publication
(10) Pub. No.: US 2024/0094332 A1
(43) Pub. Date: Mar. 21, 2024

(54) VEHICULAR RADAR SENSING SYSTEM

(71) Applicant: Magna Electronics Inc., Auburn Hills, MI (US)

(72) Inventors: Suresh Boddi, New Hudson, MI (US); Sujith Gurram, Orion Township, MI (US); Yi Luo, Northville, MI (US); Jason P. Keto, Waterford, MI (US)

(21) Appl. No.: 18/468,810

(22) Filed: Sep. 18, 2023

Related U.S. Application Data
(60) Provisional application No. 63/376,152, filed on Sep. 19, 2022.

(51) Int. Cl. G01S 7/02; G01S 13/04; G01S 13/931

(52) U.S. Cl. CPC G01S 7/027; G01S 13/04; G01S 13/931; G01S 2013/93271; G01S 2013/93272; G01S 2013/93275

(57) ABSTRACT

A vehicular radar sensing system includes a radar sensor disposed with a field of sensing within an interior of a vehicle. The radar sensor includes a plurality of transmitters and a plurality of receivers and a printed circuit board (PCB) having electronic circuitry and associated software. The electronic circuitry includes a processor operable to process outputs of the receivers. The plurality of transmitters includes a plurality of transmitting antennas, and the plurality of receivers includes a plurality of receiving antennas. The plurality of transmitting antennas is established on a surface of a glass panel of the vehicle in a transmitting antenna pattern. The plurality of receiving antennas is established on the surface of the glass panel in a receiving antenna pattern. The vehicular radar sensing system, responsive to processing of outputs of the plurality of receivers, detects presence of an occupant within the cabin of the vehicle.

### CROSS REFERENCE TO RELATED APPLICATION

The present application claims the filing benefits of U.S. provisional application Ser. No. 63/376,152, filed Sep. 19, 2022, which is hereby incorporated herein by reference in its entirety.

### FIELD OF THE INVENTION

The present invention relates generally to a vehicle sensing system for a vehicle and, more particularly, to a vehicle sensing system that utilizes one or more radar sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular radar sensing system includes a radar sensor disposed at a vehicle. The radar sensor has a field of sensing within an interior cabin of the vehicle. The radar sensor includes a plurality of transmitters that transmit radio signals and a plurality of receivers that receive radio signals. The system includes an electronic control unit (ECU) with electronic circuitry and associated software. The electronic circuitry includes a processor operable to process outputs of the receivers. The plurality of transmitters includes a plurality of transmitting antennas, and the plurality of receivers includes a plurality of receiving antennas. The plurality of transmitting antennas is established on a surface of a glass panel of the vehicle in a transmitting antenna pattern. The plurality of receiving antennas is established on the surface of the glass panel of the vehicle in a receiving antenna pattern. The vehicular radar sensing system, responsive to processing at the ECU of outputs of the plurality of receivers, detects presence of an occupant within the cabin of the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a sensing system that incorporates a radar sensor;

FIG. 2 is front view of a vehicle equipped with an antenna pattern printed on a fascia of the vehicle; and

FIG. 3 is a top view of a vehicle with an antenna pattern printed on a glass surface on a roof of the vehicle.

### DESCRIPTION OF THE PREFERRED EMBODIMENTS

A vehicular vision system and/or driver or driving assist system and/or object detection system and/or alert system operates to capture images exterior of a vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

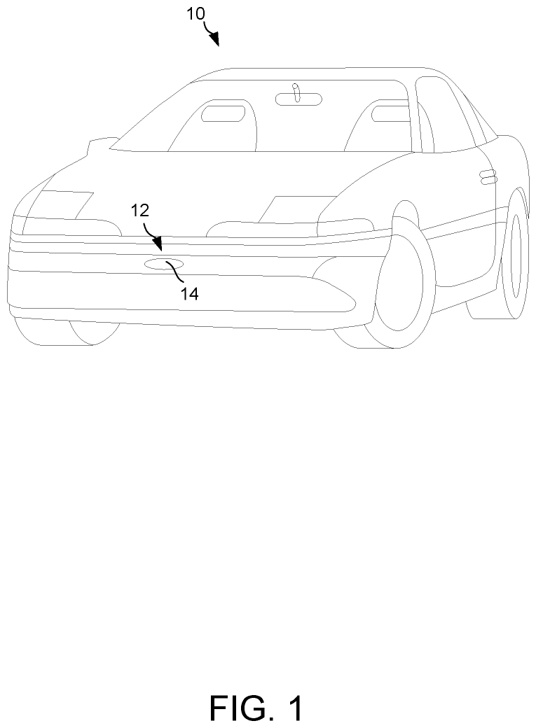

Referring now to the drawings and the illustrative embodiments depicted therein, a vehicle 10 (FIG. 1) includes an driving assistance system or sensing system 12 that includes at least one radar sensor unit, such as a forward facing radar sensor unit 14 (and the system may optionally include multiple exterior or interior facing sensors, such as cameras, radar, or other sensors, such as a rearward facing sensor at the rear of the vehicle, and a sideward/rearward facing sensor at respective sides of the vehicle, and/or such as an interior in-cabin radar sensor), which sense regions exterior or interior of the vehicle. The sensing system 12 includes a control or electronic control unit (ECU) that includes a data processor that is operable to process data captured by the radar sensor(s). The sensing system may also include a radar sensor that includes a plurality of transmitters that transmit radio signals via a plurality of antennas. The radar sensor also includes a plurality of receivers that receive radio signals via the plurality of antennas. The received radio signals are transmitted radio signals that are reflected from an object. The ECU or processor is operable to process the received radio signals to sense or detect the object that the received radio signals reflected from. The ECU or sensing system 12 may be part of a driving assist system of the vehicle, with the driving assist system controlling at least one function or feature of the vehicle (such as to provide autonomous driving control of the vehicle) responsive to processing of the data captured by the radar sensors. The data transfer or signal communication from the sensor to the ECU may comprise any suitable data or communication link, such as a vehicle network bus or the like of the equipped vehicle.

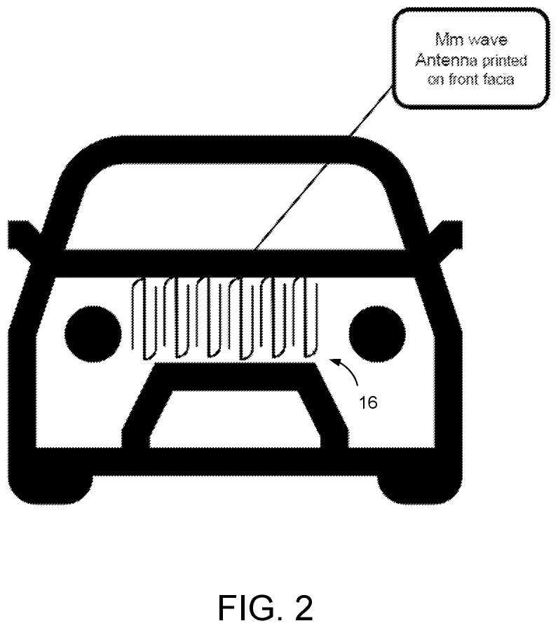

A vehicle may include a front facing radar at an exterior fascia of the vehicle such as at the front bumper or grille or rear bumper of the vehicle. Integration of these radar sensors affects the styling of the fascia and can complicate design and/or installation/integration. In implementations herein, and such as shown in FIG. 2, the radar sensor unit 14 may include a transmitting antenna pattern 16 and/or a receiving antenna pattern (e.g., an antenna pattern comprising a copper or other electrically conductive material) disposed or established or printed directly on the vehicle fascia (e.g., the circuits and electrically conductive traces may be printed or applied or established on the surface or integrated into the vehicle fascia). For example, the transmitting/receiving antenna pattern may be printed directly onto the surface of the fascia (e.g., using 3D printing or the like) or transferred (e.g., using transfer paper or the like). The antenna pattern may be printed or established at an exterior surface of the fascia (e.g., at the outermost surface or covered by an outermost coating at the exterior surface) or at an interior surface of the fascia. This enables the surface (e.g., an exterior or outer surface) of the fascia to act as an antenna for use in exterior long, mid, and/or short radar use. The electronics and circuitry associated with the radar sensor unit may be concealed within the fascia (e.g., with or near exterior lighting electronics). This improves the field of sensing of the radar sensor unit and increases the accuracy of object detection while maintaining the exterior styling without complicating integration. The radar sensor unit may utilize aspects of the radar sensing systems described in U.S. Pat. No. 11,454,719 and/or U.S. Publication No. US-2017-0222311, which are hereby incorporated herein by reference in their entireties. The antenna pattern may form any pattern on the fascia, such as a serpentine pattern, depending on the particular parameters and use cases of the radar system. The radar sensor module may include any number of antenna patterns on the fascia. For example, a first antenna pattern may be for a transmitter of the radar sensor module and a second antenna pattern may be for a receiver of the radar sensor module. The patterns may be the same or the patterns may be different. Different antenna patterns may be used for different radar sensing functions. For example, a first pattern may be used for long distance or long range object detection while a second pattern may be used for short distance or short range object detection.

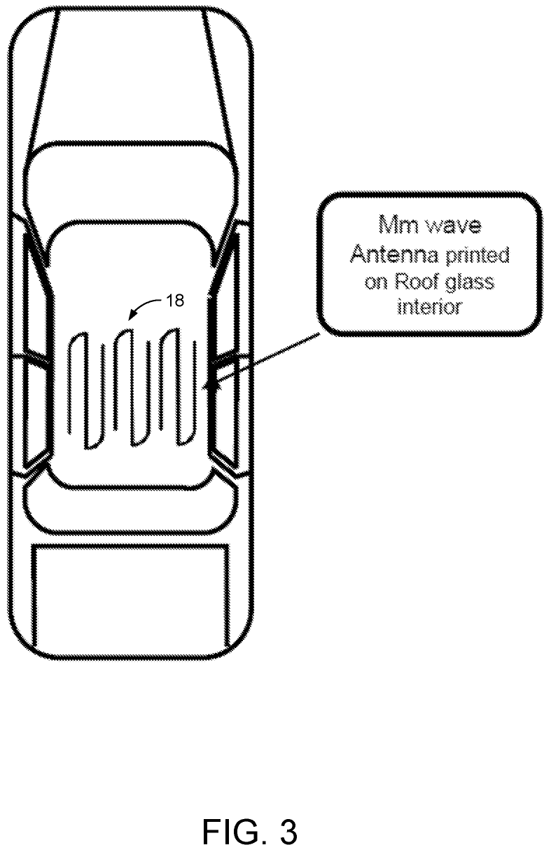

Referring now to FIG. 3, in some implementations, a radar transmitting and/or receiving antenna pattern 18 is disposed or established or printed directly on a glass surface of the vehicle, such as on a surface of a windshield, a window (e.g., a side or rear window), a moonroof, and/or a sunroof of the vehicle (e.g., the circuits and electrically conductive traces may be printed or applied or established on the surface or integrated into a vehicle glass roof panel). For example, the antenna pattern may be printed directly onto the exterior surface (or optionally on the interior surface) of the glass (e.g., using 3D printing or the like) or transferred (e.g., using transfer paper or the like). In this example, the radar sensor module may have a field of sensing that includes the interior cabin of the vehicle for in-cabin radar functions. For example, the radar sensor module may be part of a cabin monitoring system that, responsive to radar data captured by the radar sensor, detects a number and/or position of occupants within the vehicle and/or determines if there are occupants in the vehicle and whether any detected occupants are adults, pets or children (whereby the system may generate an appropriate alert if a child or pet is detected in the vehicle when the vehicle is parked). The associated electronics of the radar sensor module may be disposed within the roof (e.g., behind the headliner or behind a cloth surface, or integrated within, for example, an interior lighting module or overhead console disposed at the vehicle roof). The antenna pattern 18 may improve the field of sensing of the radar sensor unit and improve the accuracy of object detection. The antenna pattern may form any pattern on the glass, such as a serpentine pattern. The radar sensor module may include any number of antenna patterns on the glass. For example, a first antenna pattern may be for a transmitter of the radar sensor module and a second antenna pattern may be for a receiver of the radar sensor module.

The system may the radar to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular radar sensing system, the vehicular radar sensing system comprising:
a radar sensor disposed at a vehicle, wherein the radar sensor has a field of sensing within an interior cabin of the vehicle;
wherein the radar sensor comprises a plurality of transmitters that transmit radio signals and a plurality of receivers that receive radio signals;
an electronic control unit (ECU) comprising electronic circuitry and associated software;
wherein the electronic circuitry comprises a processor operable to process outputs of the receivers;
wherein the plurality of transmitters comprises a plurality of transmitting antennas, and wherein the plurality of receivers comprises a plurality of receiving antennas;
wherein the plurality of transmitting antennas is established on a surface of a glass panel of the vehicle in a transmitting antenna pattern;
wherein the plurality of receiving antennas is established on the surface of the glass panel of the vehicle in a receiving antenna pattern; and
wherein the vehicular radar sensing system, responsive to processing at the ECU of outputs of the plurality of receivers, detects presence of an occupant within the cabin of the vehicle.

2. The vehicular radar sensing system of claim 1, wherein the glass panel is at least a portion of a moonroof of the vehicle.

3. The vehicular radar sensing system of claim 1, wherein the glass panel is at least a portion of a sunroof of the vehicle.

4. The vehicular radar sensing system of claim 1, wherein the glass panel is at least a portion of a window of the vehicle.

5. The vehicular radar sensing system of claim 1, wherein the glass panel is at least a portion of a windshield of the vehicle.

6. The vehicular radar sensing system of claim 1, wherein the surface of the glass panel is an in-cabin surface of the glass panel of the vehicle.

7. The vehicular radar sensing system of claim 1, wherein the transmitting antenna pattern comprises a serpentine pattern.

8. The vehicular radar sensing system of claim 7, wherein the receiving antenna pattern comprises a second serpentine pattern.

9. The vehicular radar sensing system of claim 1, wherein the ECU is disposed at an overhead console of the vehicle.

10. The vehicular radar sensing system of claim 1, wherein the ECU is disposed at an interior lighting module of the vehicle.

11. A vehicular radar sensing system, the vehicular radar sensing system comprising:
a radar sensor disposed at a vehicle, wherein the radar sensor has a field of sensing exterior of the vehicle;
wherein the radar sensor comprises a plurality of transmitters that transmit radio signals and a plurality of receivers that receive radio signals;
an electronic control unit (ECU) comprising electronic circuitry and associated software;
wherein the electronic circuitry comprises a processor operable to process outputs of the receivers;
wherein the plurality of transmitters comprises a plurality of transmitting antennas, and wherein the plurality of receivers comprises a plurality of receiving antennas;
wherein the plurality of transmitting antennas is established at an exterior surface of an exterior portion of the vehicle in a transmitting antenna pattern;
wherein the plurality of receiving antennas is established at the exterior surface of the exterior portion of the vehicle in a receiving antenna pattern; and
wherein the vehicular radar sensing system, responsive to processing at the ECU of outputs of the plurality of receivers, detects presence of an object exterior of the vehicle.

12. The vehicular radar sensing system of claim 11, wherein the exterior portion comprises a fascia of the vehicle.

13. The vehicular radar sensing system of claim 11, wherein the exterior portion comprises a front bumper of the vehicle.

14. The vehicular radar sensing system of claim 11, wherein the exterior portion comprises a grille of the vehicle.

15. The vehicular radar sensing system of claim 11, wherein the exterior portion comprises a rear bumper of the vehicle.

16. The vehicular radar sensing system of claim 11, wherein the transmitting antenna pattern comprises a serpentine pattern.

17. The vehicular radar sensing system of claim 16, wherein the receiving antenna pattern comprises a second serpentine pattern.

18. The vehicular radar sensing system of claim 11, wherein the ECU comprises second electronic circuitry operable to control at least one exterior light of the vehicle.

19. The vehicular radar sensing system of claim 11, wherein the transmitting antenna pattern is different from the receiving antenna pattern.

20. The vehicular radar sensing system of claim 11, wherein the transmitting antenna pattern is the same as the receiving antenna pattern.

21. A vehicular radar sensing system, the vehicular radar sensing system comprising:
a radar sensor disposed at a vehicle, wherein the radar sensor has a field of sensing within an interior cabin of the vehicle;
wherein the radar sensor comprises a plurality of transmitters that transmit radio signals and a plurality of receivers that receive radio signals;
an electronic control unit (ECU) comprising electronic circuitry and associated software;
wherein the electronic circuitry comprises a processor operable to process outputs of the receivers;
wherein the plurality of transmitters comprises at least one transmitting antenna, and wherein the plurality of receivers comprises at least one receiving antenna;
wherein the at least one transmitting antenna is established on an interior surface of a glass panel of the vehicle in a transmitting antenna pattern, and wherein the transmitting antenna pattern comprises a first serpentine pattern;
wherein the at least one receiving antenna is established on the interior surface of the glass panel of the vehicle in a receiving antenna pattern, and wherein the receiving antenna pattern comprises a second serpentine pattern, and wherein the second serpentine pattern is different from the first serpentine pattern; and
wherein the vehicular radar sensing system, responsive to processing at the ECU of outputs of the plurality of receivers, detects presence of an occupant within the cabin of the vehicle.

22. The vehicular radar sensing system of claim 21, wherein the glass panel is at least a portion of a moonroof of the vehicle.

23. The vehicular radar sensing system of claim 21, wherein the glass panel is at least a portion of a sunroof of the vehicle.

24. The vehicular radar sensing system of claim 21, wherein the glass panel is at least a portion of a window of the vehicle.

25. The vehicular radar sensing system of claim 21, wherein the glass panel is at least a portion of a windshield of the vehicle.
